(19) United States
(12) Patent Application Publication
(10) Pub. No.: US 2007/0155974 A1
(43) Pub. Date: Jul. 5, 2007

(54) Transition metal catalysts

(76) Inventors: Hansjorg Grutzmacher, Dielsdorf (CH); Elisabetta Piras, Zurich (CH); Florian Lang, Mellingen (CH)

Correspondence Address: LANXESS CORPORATION, 111 RIDC PARK WEST DRIVE, PITTSBURGH, PA, 15275-1112, US

(21) Appl. No.: 11/639,881

(22) Filed: Dec. 15, 2006

(30) Foreign Application Priority Data
Dec. 23, 2005 (DE) 10 2005 062 363.8

(51) Int. Cl. C07F 15/00; C07F 9/02

(52) U.S. Cl. 556/20; 568/9

(57) ABSTRACT

The present invention relates to stereoisomerically enriched phosphorus compounds, transition metal catalysts which can be prepared therefrom and their use in stereoselective catalytic processes, and also a process for preparing the stereoisomerically enriched phosphorus compounds.

The present invention relates to stereoisomerically enriched phosphorus compounds, transition metal catalysts which can be prepared therefrom and their use in stereoselective catalytic processes, and also a process for preparing the stereoisomerically enriched phosphorus compounds.

It is known from WO 2003048175 that transition metal complexes of olefin-phosphane compounds are suitable for homogeneously catalyzed reactions such as, in particular, hydrogenations and hydrogen additions. The preparation of such olefin-phosphane compounds is usually carried out using secondary phosphanes (see also Thomaier et al., New. J. Chem. 1998, 947-958 and Deblon et al., New. J. Chem. 2001, 25, 83-92). As an alternative, they can be prepared via phosphane oxides as described in EP 1 475 384 A.

The advantage of the abovementioned olefin-phospane compounds is the ease with which they can be modified electronically and sterically, which is why there was a need to provide particularly suitable catalysts which allow organic compounds to be prepared enantioselectively in an efficient way.

It has now surprisingly been found that enantiomerically enriched compounds of the formula (I) are particularly suitable as ligands, where, in the formula (I), 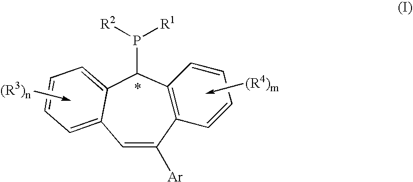
R¹ and R² are each, independently of one another, a monovalent radical containing from 1 to 30 carbon atoms or
the moiety PR¹R² is a 5-to 9-membered heterocyclic radical which contains a total of from 2 to 50 carbon atoms and can contain up to 3 further heteroatoms selected from the group consisting of oxygen and nitrogen and
n and m indicate the number of substituents other than hydrogen on the aromatic ring and can each be, independently of one another, zero, one, two, three or four, R³ and R⁴ are each selected independently from the group consisting of fluorine, chlorine, bromine, iodine, nitro, free or protected formyl, C₁-C₁₂-alkyl, C₁-C₁₂-alkoxy, C₁-C₁₂-halogenalkoxy, C₁-C₁₂-halogenalkyl, C₅-C₁₄-aryl, C₆-C₁₅-arylalkyl and radicals of the formula (II),
   A-B-C-D (II)
   where, independently of one another
   A is absent or is an alkylene radical having from 1 to 12 carbon atoms or an alkenylene radical having from 2 to 12 carbon atoms and
   B is absent or is oxygen, sulphur or NR⁵,
   where
   R⁵ is hydrogen, C₁-C₈-alkyl, C₆-C₁₅-arylalkyl or C₅-C₁₄-aryl and
   C is a carbonyl group and
   D is R⁶, OR⁶, NHR⁷ or N(R⁷)₂,
   where
   R⁶ is C₁-C₈-alkyl, C₆-C₁₅-arylalkyl or C₅-C₁₄-aryl and
   the radicals R⁷ are each, independently of one another C₁-C₈-alkyl, C₆-C₁₄-arylalkyl or C₅-C₁₄-aryl or the moiety N(R⁷)₂ is a 5- or 6-membered cyclic amino radical,
   and radicals of the formula (IIIa-g)
      A-D (IIIa)
      A-SO₂-D (IIIb)
      A-NR⁶—SO₂R⁶ (IIIc)
      A-SO₃Z (IIId)
      A-PO₃Z₂ (IIIe)
      A-COZ (IIIf)
      A-CN (IIIg)
   where A, D and R⁶ are as defined under the formula (II) and Z is hydrogen or a metal ion equivalent,
Ar is an aryl radical and
* denotes, independently of the depiction chosen above, that all possible stereoisomerically enriched compounds are encompassed.

For the purposes of the invention, the terms stereoisomerically enriched (enantiomerically enriched or diastereomerically enriched) refer to stereoisomerically pure (enantiomerically pure or diastereomerically pure) compounds or mixtures of stereoisomers (enantiomers or diastereomers) in which one stereoisomer (enantiomer or diastereomer) is present in a greater proportion than another or the other.

In the case of compounds of the formula (I), stereoisomerically enriched means, by way of example and preferably, a content of one stereoisomer of from 50% to 100%, particularly preferably from 70% to 100% and very particularly preferably from 95 to 100%.

Particularly preferred stereoisomerically enriched compounds are enantiomerically enriched compounds.

For the purposes of the invention, asymmetric catalytic processes are syntheses of chiral compounds which take place in the presence of catalysts and in which the products are formed in stereoisomerically enriched form.

At this point, it may be pointed out that all combinations of preferred ranges given below for compounds of the formula (I) are encompassed by the invention.

Aryl is generally, in each case independently, a heteroaromatic radical having from 5 to 14 skeletal carbon atoms in which no, one, two, three or four skeletal carbon atoms per ring, but at least one skeletal carbon atom in the total molecule, can be replaced by heteroatoms selected from the group consisting of nitrogen, sulphur and oxygen or a carbocyclic aromatic radical having from 6 to 14 skeletal carbon atoms. It may be pointed out that, for the purposes of the present invention, heteroatoms are counted as skeletal carbon atoms in the interests of simplicity. In this sense, pyridine, for example, is accordingly a C₆-aryl radical.

Examples of monocyclic, bicyclic or tricyclic carbocyclic aromatic radicals having from 6 to 14 skeletal carbon atoms are phenyl, biphenyl, naphthyl, phenanthrenyl, anthracenyl and fluorenyl; monocyclic, bicyclic or tricyclic heteroaromatic radicals having from 5 to 14 skeletal carbon atoms in which no, one, two or three skeletal carbon atoms per ring, but at least one skeletal carbon atom in the total molecule, can be replaced by heteroatoms selected from the group consisting of nitrogen, sulphur and oxygen, are, for example, pyrrolyl, pyrrolidinyl, pyridinyl, pyrimidinyl, imidazolyl, oxazolyl, benzofuranyl, triazolyl, tetrazolyl, furanyl, thiophenyl, dibenzofuranyl, indolyl or quinolinyl.

Furthermore, the carbocyclic aromatic radical or heteroaromatic radical can be substituted by up to five identical or different substituents per ring which are selected from the group consisting of hydroxy, chlorine, fluorine, iodine, bromine, cyano, nitro, nitroso, tri(C₁-C₈-alkyl)siloxyl and radicals of the formulae (II) and (IIIa) to (IIIg).

For the purposes of the invention, the definitions and preferred ranges also apply analogously to aryloxy substituents and the aryl part of an arylalkyl radical.

Protected formyl is a formyl radical which has been protected by conversion into an aminal, acetal or mixed aminal-acetal, with the aminals, acetals and mixed aminal-acetals being able to be acyclic or cyclic.

Protected formyl is, by way of example and preferably, a 1,1-(2,4-dioxycyclopentanediyl) radical.

For the purposes of the invention, alkyl or alkylene, or alkoxy or alkenyl, are each, independently of one another, a straight-chain, cyclic, branched or unbranched alkyl or alkylene or alkenyl or alkoxy radical which may be further substituted by C₁-C₄-alkoxy so that each carbon atom of the alkyl or alkylene or alkoxy or alkenyl radical bears not more than one heteroatom selected from the group consisting of oxygen, nitrogen and sulphur.

The same applies to the alkylene part of an arylalkyl radical.

For the purposes of the invention, C₁-C₆-alkyl is, for example, methyl, ethyl, 2-ethoxyethyl, n-propyl, isopropyl, n-butyl, tert-butyl, n-pentyl, cyclohexyl or n-hexyl, C₁-C₈-alkyl may also be, for example, n-heptyl, n-octyl or isooctyl, C₁-C₁₂-alkyl, may also be, for example, norbornyl, adamantyl, n-decyl or n-dodecyl and C₁-C₁₈-alkyl may also be n-hexadecyl or n-octadecyl.

For the purposes of the invention, C₁-C₄-alkylene is, for example, methylene, 1,1-ethylene, 1,2-ethylene, 1,1-propylene, 1,2-propylene, 1,3-propylene, 1,1-butylene, 1,2-butylene, 2,3-butylene and 1,4-butylene, and C₁-C₈-alkylene may also be 1,5-pentylene, 1,6-hexylene, 1,1-cyclohexylene, 1,4-cyclohexylene, 1,2-cyclohexylene and 1,8-octylene.

For the purposes of the invention, C₁-C₄-alkoxy is, for example, methoxy, ethoxy, isopropoxy, n-propoxy, n-butoxy or tert-butoxy, and C₁-C₈-alkoxy may also be cyclohexyloxy.

For the purposes of the invention, C₂-C₈-alkenyl is, for example, allyl, 3-propenyl or 4-butenyl.

For the purposes of the invention, haloalkyl and haloalkoxy are each, independently of one another, a straight-chain, cyclic, branched or unbranched alkyl or alkoxy radical which may be monosubstituted, polysubstituted or persubstituted by halogen atoms. Radicals which are persubstituted by fluorine are referred to as perfluoroalkyl or perfluoroalkoxy.

For the purposes of the invention, C₁-C₆-haloalkyl is, for example, trifluoromethyl, 2,2,2-trifluoroethyl, chloromethyl, fluoromethyl, bromomethyl, 2-bromoethyl, 2-chloroethyl, nonafluorobutyl, C₁-C₈-haloalkyl may also be, for example, n-perfluorooctyl, and C₁-C₁₂-haloalkyl may also be, for example, n-perfluorododecyl.

For the purposes of the invention, C₁-C₄-haloalkoxy is, for example, trifluoromethoxy, 2,2,2-trifluoroethoxy, 2-chloroethoxy, heptafluoroisopropoxy, and C₁-C₈-haloalkoxy may also be n-perfluorooctyloxy.

The preferred substitution pattern is defined below:
R¹ and R² are preferably each, independently of one another, C₁-C₁₈-alkyl, C₃-C₁₂-alkenyl, C₆-C₂₄-aryl.
R¹ and R² are particularly preferably each, independently of one another, C₁-C₁₂-alkyl or C₆-C₁₄-aryl.
R¹ and R² are very particularly preferably each independently and even more preferably each identically isopropyl, tert-butyl, cyclohexyl, benzyl, o-, m-, p-tolyl, 2,6-dimethylphenyl, 3,5-di-tert-butylphenyl, p-trifluoromethylphenyl, 3,5-bis(trifluoromethylphenyl), p-tert-butylphenyl, o-, m-, p-anisyl, or 2,6-dimethoxyphenyl and even more preferably phenyl.
n and m are preferably each identically 0 or 1.
Ar is particularly preferably phenyl which is further substituted by no, one or two substituents selected from the group consisting of C₁-C₄ alkyl.

Very particularly preferred compounds of the formula (I) are:

(S)- and (R)-10-phenyl-5-diphenylphosphanyl-5H-dibenzo[a,d]cycloheptene (S-^{ph}troppp^{Ph}, R-^{Ph}tropp^{Ph}), (S)- and (R)-10-phenyl-5-di(o-tolyl)phosphanyl-5H-dibenzo[a,d]cycloheptene (S-^{Ph}tropp^{o-Tol}, R-^{Ph}tropp^{o-Tol}), (S)- and (R)-10-phenyl-5-di(m-tolyl)phosphanyl-5H-dibenzo[a,d]cycloheptene (S-^{Ph}tropp^{m-Tol} R-^{Ph}tropp^{m-Tol}) and (S)- and (R)-10-phenyl-5-di(p-tolyl)phosphanyl-5H-dibenzo[a,d]cycloheptene (S-^{Ph}tropp^{p-Tol} R-^{Ph}tropp^{p-Tol}) and greater preference being given to (S)- and (R)-10-phenyl-5-diphenylphosphanyl-5H-dibenzo[a,d]cycloheptene (S-^{Ph}tropp^{Ph}, R-^{Ph}tropp^{Ph}).

Furthermore, the invention encompasses a process for preparing compounds of the formula (I), which is characterized in that
in a first step a),
compounds of the formula (IV) 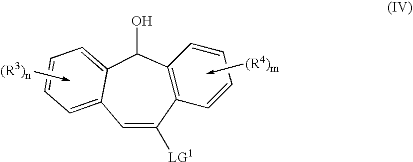
where R³ and R⁴ and also n and m are as defined above and
LG¹ is halogen, perfluorocarboxyl or an organic sulphonate,
are reacted with compounds of the formula (V)
   Ar-LG² (V)
where Ar is an aryl radical and LG² is halogen, perfluorocarboxyl, B(OH)₂ or an organic sulphonate,
in the presence of a catalyst to convert them into compounds of the formula (VI) 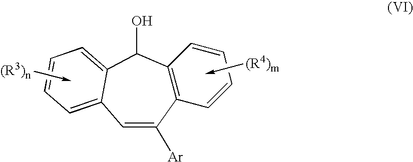
in a step b), the compounds of the formula (VI) are reacted with compounds of the formula (VII)
   R¹R²PHal (VII)
where R¹ and R² are as defined above and Hal is chlorine, bromine or iodine, preferably chlorine,
in the presence of acid to convert them into compounds of the formula (VIII) 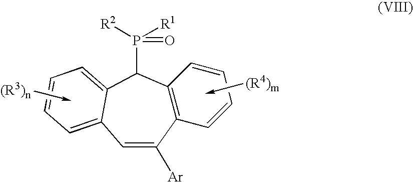
in a step c), the compounds of the formula (VIII) are converted by chromatography into stereoisomerically enriched compounds of the formula (VIII) and
in a step d), the stereoisomerically enriched compounds of the formula (VI) are converted by reduction into compounds of the formula (I).

In step a) of the process of the invention, the compounds of the formula (IV) are reacted with compounds of the formula (V) in the presence of a catalyst to form compounds of the formula (VI). The reaction can, if desired and preferably, be carried out in the presence of an organic solvent. Suitable catalysts are, in particular, ones which can be used for reactions of the Heck or Suzuki type, for example palladium complexes. In a preferred embodiment, compounds of the formula (W) are reacted with arylboronic acids of the formula (V) in the presence of tetrakis(triphenylphosphine)palladium and an alkali metal carbonate in step a).

In step b) of the process of the invention, the compounds of the formula (VI) are reacted with compounds of the formula (VII) in the presence of acid to form compounds of the formula (VIII). The reaction can, if desired and preferably, be carried out in the presence of an organic solvent, provided that the solvent is at least essentially inert toward the acid used in the particular case.

Suitable organic solvents are, for example:

Aliphatic or aromatic, halogenated or unhalogenated hydrocarbons such as various petroleum spirits, benzene, toluene, xylene, chlorobenzene, dichlorobenzene, various petroleum ethers, hexane, cyclohexane, dichloromethane, chloroform, carbon tetrachlorite; ethers such as diethyl ether, methyl tert-butyl ether, diisopropyl ether, dioxane, tetrahydrofuran or ethylene glycol dimethyl or -diethyl ether; amides such as N,N-dimethylformamide, N,N-dimethylacetamide, N-methyl-formanilide, N-methylpyrrolidone, N-methylcaprolactam or hexamethylphosphoramide; sulphoxides, such as dimethyl sulphoxide, sulphones such as tetramethylene sulphone, alcohols such as methanol, ethanol, n- or i-propanol, ethylene glycol monomethyl ether, ethylene glycol monoethyl ether, diethylene glycol monomethyl ether, diethylene glycol monoethyl ether, or mixtures of such organic solvents. Preferred organic solvents are ethers.

Preferred acids are ones which, based on an aqueous reference scale and 25° C., a pKₐ of 5.5 or less.

These are, for example, (C₁-C₁₂-alkyl)carboxylic acids, (C₁-C₁₂-haloalkyl)carboxylic acids, (C₁-C₁₂-haloalkyl)sulphonic acids, (C₁-C₁₂-alkyl)sulphonic acids, (C₅-C₁₄-aryl)sulphonic acids, hydrogen chloride, hydrogen bromide and hydrogen iodide, if desired as a solution in acetic acid, sulphuric acid, orthophosphoric and polyphosphoric acids, hexafluorophosphoric acid and tetrafluoroboric acid.

In step c) of the process of the invention, the separation of stereoisomers is carried out. In the case of mixtures of diastereomers, the separation can be carried out, for example, chromatographically or by fractional crystallization, while in the case of mixtures of enantiomers it can be carried out, for example, by fractional crystallization in the presence of enantiomerically enriched auxiliary reagent or by chromatography on an at least enantiomerically enriched column material.

In step d) of the process of the invention, stereoisomerically enriched compounds of the formula (VIII) are reduced to compounds of the formula (I). This reduction preferably takes place in the presence of silicon-hydrogen compounds. Preferred silicon-hydrogen compounds are polymethylhydrosiloxane (PHMS) or compounds of the formula (IX),
(R⁸)ₓSiH₍₄₋ₓ₎ (IX)
where
x is 0, 1, 2 or 3 and
the radicals R⁸ are each, independently of one another, C₁-C₈-alkyl, C₁-C₈-alkoxy, C₅-C₁₄-aryl or chlorine, with even greater preference being given to trichlorosilane.

The compounds of the formula (I) which can be prepared according to the invention are particularly suitable for use as ligands in asymmetric catalytic processes.

The scope of the invention therefore also encompasses a process for preparing stereoisomerically enriched chiral compounds, which is characterized in that it is carried out in the presence of compounds of the formula (I).

Catalysts suitable for use in asymmetric catalytic processes are, in particular, ones which contain isolated transition metal complexes of the compounds of the formula (I) and also ones which contain transition metal complexes produced in a reaction medium from transition metal compounds and compounds of the formula (I). The catalysts mentioned are likewise encompassed by the invention. The transition metal complexes described can, if desired, be present in the form of isomers such as cis/trans isomers, coordination isomers or solvation isomers. Such isomers are likewise encompassed by the invention.

Preferred transition metal complexes are ones which contain at least one transition metal selected from the group consisting of cobalt, rhodium, iridium, nickel, palladium, platinum, copper, osmium and ruthenium and at least one compound of the formula (I).

Preferred transition metals are selected from the group consisting of rhodium, iridium, nickel, palladium and ruthenium, and particularly preferred transition metals are selected from the group consisting of iridium and rhodium.

Suitable transition metal compounds from which transition metal complexes according to the invention can be prepared using compounds of the formula (I) are, for example, compounds of the formula (Xa)
M¹(Y¹)ₚ (Xa)
where
M¹ is ruthenium, rhodium, iridium, nickel, palladium, platinum or copper and
Y¹ is chloride, bromide, acetate, nitrate, methanesulphonate, trifluoromethanesulfonate, allyl, methallyl or acetylacetonate and
p is 3 in the case of ruthenium, rhodium and iridium,
   2 in the case of nickel, palladium and platinum and
   1 in the case of copper,
or compounds of the formula (Xb),
   M²(Y²)ₚB¹₂ (Xb)
   where
M² is ruthenium, rhodium iridium, nickel, palladium, platinum or copper and
Y² is hydroxy, chloride, bromide, acetate, methanesulphonate, trifluoromethanesulphonate, tetrafluoroborate, hexafluorophosphate, perchlorate, hexafluoroantimonate, tetra(3,5-bistrifluoromethylphenyl)borate or tetraphenylborate and
p is 1 in the case of rhodium and iridium,
   2 in the case of nickel, palladium, platinum and ruthenium and
   1 in the case of copper,
B¹ is a C₂-C₁₂-alkene such as ethylene or cyclooctene, or a nitrile such as acetonitrile, benzonitrile or benzyl nitrile or
   the moiety B¹₂ is a (C₄-C₁₂)diene such as norbornadiene or 1,5-cyclooctadiene,
      or compounds of the formula (Xc),
      [M³B²Y¹₂]₂ (Xc)
      where
M³ is ruthenium and
B² is an aryl radical such as cymolene, mesityl, phenyl or cyclooctadiene, norbornadiene or methallyl, or compounds of the formula (Xd)
   M⁴ p[M⁵(Y³)₄] (Xd),
   where
M⁴ is palladium, nickel, iridium or rhodium and
Y³ is chloride or bromide and
M⁵ is lithium, sodium, potassium, ammonium or organic ammonium and
p is 3 in the case of rhodium and iridium and is 2 in the case of nickel, palladium and platinum,
   or compounds of the formula (Xe)
   [M⁶(B³)₂]An (Xe),
   where
M⁶ is iridium or rhodium and
B³ is a (C₄-C₁₂)-diene such as norbornadiene or 1,5-cyclooctadiene and
An is a noncoordinating or weakly coordinating anion such as methanesulphonate, trifluoromethanesulphonate (OTf), tetrafluoroborate, hexafluoro-phosphate, perchlorate, hexafluoroantimonate, tetra(3,5-bistrifluoromethylphenyl)borate, tetraphenylborate or a closo-boranate or a carboboranate.

Further suitable transition metal compounds are, for example, Ni(1,5-cyclooctadiene)₂, Pd₂(dibenzylideneacetone)₃, Pt(norbornene)₃, Ir(pyridine)₂(1,5-cyclooctadiene), [Cu(CH₃CN)₄]BF₄ and [Cu(CH₃CN)₄]PF₆ or multinuclear bridged complexes such as [Rh(1,5-cyclooctadiene)Cl]₂, [Rh(1,5-cyclooctadiene)OH]₂ and [Rh(1,5-cyclooctadiene)Br]₂, [Rh(ethene)₂Cl]₂, [Rh(cyclooctene)₂Cl]₂ or the analogous iridium compounds.

Preferred metal compounds are:

[Rh₂(μ₂-Cl)₂(CO)₄], [Ir₂(μ₂—Cl)₂(CO)₄], [Ir₂(μ₂—Cl)₂(coe)₄], [Rh₂(μ₂-Cl)₂(coe)₄], [Rh₂(μ₂-Cl)₂(C₂H₄)₄], [Ir₂(μ₂-Cl)₂(C₂H₄)₄] [Rh(cod)Cl]₂, [Rh(cod)OH]₂, [Rh(cod)₂Br], [Rh(cod)₂]ClO₄, [Rh(cod)₂]BF₄, [Rh(cod)₂]PF₆, [Rh(cod)₂]OTf, [Rh(cod)₂]BAr₄ (Ar=3,5-bistrifluoromethylphenyl) [Rh(cod)₂]SbF₆, [Ir(cod)Cl]₂, [Ir(cod)OH]₂, [Ir(cod)₂Br], [Ir(cod)₂]ClO₄, [Ir(cod)₂]BF₄, [Ir(cod)₂]PF₆, [Ir(cod)₂]OTf, [Ir(cod)₂]BAr₄ (Ar=3,5-bistrifluoromethylphenyl) [Ir(cod)₂]SbF₆, [Rh(nbd)Cl]₂, (nbd=norbornadiene) [Rh(nbd)₂Br], [Rh(nbd)₂]ClO₄, [Rh(nbd)₂]BF₄, [Rh(nbd)₂]PF₆, [Rh(nbd)₂]OTf, [Rh(nbd)₂]BAr₄ (Ar=3,5-bistrifluoromethylphenyl) [Rh(nbd)₂]SbF₆ RuCl₂(nbd), [Ir(nbd)₂]PF₆, [Ir(nbd)₂]ClO₄, [Ir(nbd)₂]SbF₆ [Ir(nbd)₂]BF₄, [Ir(nbd)₂]OTf, [Ir(nbd)₂]BAr₄ (Ar=3,5-bistrifluoromethylphenyl) and Ir(pyridine)₂(nbd).

The molar amount of the transition metal in the transition metal compound used can be, for example, from 50 to 300 mol %, based on the compound of the formula (I) used;

when isolated transition metal complexes of the compounds of the formula (I) are used, the ratio of transition metal to compounds of the formula (I) is preferably 1:1 or 1:2.

Particularly preferred isolated complexes are:

S,S- and R,R-[Ir(^{Ph}tropp^{Ph})₂]OTf, S- and R-[Rh(cod)(^{Ph}tropp^{Ph})]OTf, S- and R-[Rh(MeCN)₂(^{Ph}tropp^{Ph})]PF₆ and S- and R-[RhCl(MeCN)(^{Ph}tropp^{Ph})].

The catalysts of the invention are particularly suitable for use in processes for preparing stereoisomerically enriched compounds.

Preferred processes for preparing stereoisomerically enriched compounds are asymmetric 1,4-additions such as, in particular, the coupling of arylboronic acids with α,β-unsaturated ketones and α,β-unsaturated carboxylic acid derivatives and also asymmetric hydrogenations, in particular of α,β-unsaturated carboxylic acid derivatives.

The following examples illustrate the advantageous effects of the invention.

### EXAMPLES

### Example 1

### Synthesis of 10-phenyl-5H-dibenzo[a,d]cyclohepten-5-ol (^{ph}tropOH)

In a 250 ml flask, 10-broml-5H-dibenzo[a,d]cyclohepten-5-ol (4.0 g, 13.9 mmol) was admixed with 100 ml of dimethoxyethane. Pd(OAc)₂ (93 mg, 0.4 mmol), Ph₃P (349 mg, 1.3 mmol), a degassed solution of Na₂CO₃ (9 ml, 2 M) and PhB(OH)₂ (2.0 g, 16.6 mmol) were added and the mixture was refluxed for 18 hours. After addition of 30 ml of H₂O, the product was extracted with ethyl acetate (3×30 ml), the combined organic phases were dried over Na₂SO₄, filtered and freed of volatile compounds. The resulting residue was purified by chromatography (eluent: AcOEt/n-hexane 2/8). Yield: 3.9 g (97%).

¹³C-NMR (75.5 MHz, CDCl₃): δ70.9 (br, CH_{benz}), 120.9 (br, 2C, CHₐᵣ), 125.9 (br, CHₐᵣ), 126.1 (br, 1C, CHₐᵣ), 127.72 (CHₐᵣ), 127.9 (br, CHₐᵣ), 128.34 (CHₐᵣ), 128.45 (CHₐᵣ), 128.92 (CHₐᵣ), 129.1 (br, CHₐᵣ), 129.97 (br, 2C, CHₐᵣ), 132.4 (br, C_{quat}), 133.6 (br, C_{quat}), 141.8 (br, C_{quat}), 142.6 (br, C_{quat}), 143.3 (br, C_{quat}), 143.57(C_{quat}).

### Example 2

### Synthesis of R- and S-(5-diphenyloxophosphoranyl-10-phenyldibenzo[a,d]cycloheptene) (^{Ph}troppo^{ph})

520 mg of 5-hydroxy-10-phenyl-dibenzo[a,d]cycloheptene (1.8 mmol) in 15 ml of CH₂Cl₂ were admixed with 0.15 ml of CF₃COOH (1.13 mmol). The solution became red and 0.33 ml of chlorodiphenylphosphane (2.26 mmol) was added. Another 0.15 ml of CF₃COOH (1.13 mmol) was subsequently added to the reaction mixture. This gave a clear yellow solution which was stirred at room temperature for 2 hours. 20 ml of Na₂CO₃ (18% in H₂O) were subsequently added. The organic phase was separated off and the aqueous phase was extracted with 3×20 ml of CH₂Cl₂. The combined organic phases were dried over MgSO₄ and the solvent was subsequently evaporated. The racemidic product was obtained (660 mg, 80%). The two enantiomers were subsequently separated by means of preparative HPLC (column material OD-H [cellulose triphenylcarbamate] using a mixture of n-hexane/isopropanol 98/2 (% by volume) as eluent:

Retention times: R-isomer: 8.0 min., [α]_{D}=−27.8, S isomer: 10.4 min., [α]_{D}=20.9. Melting point: 95-100° C., ³¹P NMR: 27.3 ppm-¹H NMR: 5.15 (d, ²JPH=13 Hz, 1H, CHP), 6.50 (s, 1H, ═CH), 7.0-7.9 (m, 23H, Hₐᵣₒₘ).

### Example 3

### Synthesis of S-5-diphenylphosphanyl-10-phenyldibenzo[a,d]cycloheptene (S-^{ph}tropp^{ph})

2.0 g of S-(5-diphenyloxophosphoranyl-10-phenyldibenzo[a,d]cycloheptene) (4.3 mmol) were dissolved in 100 ml of toluene and 11.5 g of SiHCl₃ (85 mmol) were added. The reaction mixture was heated at 90° C. for 18 hours. After cooling, 70 ml of 20% deoxygenated NaOH were added with cooling. The organic phase was separated off and dried over MgSO₄. Taking off all volatile components and recrystallization from methylene chloride gave the product (1.75 g, 90%) in the form of colourless crystals.

³¹P NMR (CDCl₃): −13.1 ppm-¹H NMR: 4.99 (d, ²J_{PH}=6 Hz, 1H, CHP), 6.90 (d, J_{PH}=6 Hz, 1H, ═CH), 7.0-7.53 (m, 23H, Harom).

### Example 4

### Synthesis of [Rh(cod)(S-^{Ph}tropp^{Ph})]OTf

A solution of [Rh(cod)₂]OTf (0.08 g, 0.17 mmol) in 2 ml of CH₂Cl₂ was added dropwise to a solution of S-^{ph}tropp^{ph} (0.08 g, 0.17 mmol) in 1 ml of CH₂Cl₂. The red solution was stirred for 30 minutes and the solution was subsequently evaporated to dryness. The red solid was dissolved in a little dichloromethane and the solution was covered with a layer of hexane. After 18 hours, 0.13 g of red crystals were obtained (yield: 90%).

³¹P-NMR (121.5 MHz, CDCl₃): δ=79.1 (d, ¹J_{RhP}=163.2)

¹⁰³Rh-NMR (12.6 MHz, CDCl₃): δ=377.1 (d, ¹J_{RhP}=163.2).

### Example 5

### Synthesis of [Rh(CH₃CN)₂(S-^{Ph}tropp^{Ph})]PF₆

In a 10 ml Schlenk flask, [Rh₂(μ₂—Cl)₂(CO)₄] (40 mg, 0.10 mmol), S-^{ph}tropp^{ph} (93 mg, 0.20 mmol) and TlPF₆ (72 mg, 0.20 mmol) were admixed with 3 ml of CH₃CN. The liberation of CO and the precipitation of TlCl were immediately observed. The orange suspension was filtered through Celite and the filtrate was evaporated to dryness under reduced pressure. This gave 156 mg (95% of theory) of the desired product.

³¹P-NMR (121.5 MHz, CD₃CN): δ=−144.4 (sept, ¹J_{PF}=706.5, 1 P, PF₆) 93.8 (d, ¹J_{Rhp}=158.2).

¹⁰³Rh-NMR (12.6 MHz, CD₃CN): δ=596.2 (dd, ¹J_{RhP}=158.2, ²J_{RhH}=2.9).

### Example 6

### Synthesis of [Rh₂(μ₂-Cl)₂(S-^{Ph}tropp^{Ph})₂] and [RhCl(MeCN)(S-^{Ph}tropp^{Ph})]

A mixture of [Rh₂(μ₂-Cl)₂(C₂H₄)₄] (9 mg, 23 μmol) and S-^{Ph}tropp^{Ph} (21 mg, 46 μmol) in 1 ml of THF was stirred at room temperature for 1 hour. The solvent was removed and [Rh₂(μ₂-Cl)₂(^{Ph}tropp^{Ph})₂] was precipitated as an orange powder from methylene chloride and hexane (25 mg, 93%). The NMR spectrum was recorded in CD₃CN, which led to the formation of [RhCl(CD₃CN)(^{Ph}tropp^{Ph})].

³¹P-NMR (121.5 MHz, CDCl₃, 5% CD₃CN): δ=99.3 (d, J_{RhP}=197).

### Example 7

### Synthesis of [Ir(S-^{Ph}tropp^{Ph})₂]OTf

A solution of [Ir₂(μ₂—Cl)₂(coe)₄] (coe=cyclooctene, 200 mg, 0.22 mmol) in 5 ml of THF was added dropwise to a solution of S-^{Ph}tropp^{Ph} (403 mg, 0.89 mmol) in 5 ml of THF and the mixture was stirred for one hour. AgOTf (114 mg, 0.45 mmol) was added and the mixture was stirred for another 5 hours. The suspension formed was filtered and the filtrate was evaporated to dryness. Reprecipitation from methylene chloride and hexane gave the product in the form of deep red crystals (540 mg, yield: 97%).

³¹P-NMR (121.5 MHz, CD₂Cl₂): δ=52.9 (s)

Catalyst Experiments

### Example 8

### 1,4-addition of PhB(OH)₂ onto cyclohex-2-enone

A solution of [Rh₂(μ₂—Cl)₂(C₂H₄)₄] (10 mg, 26 μmol) and S-^{Ph}tropp^{Ph} (24 mg, 53 μmol) in 1,4-dioxane (3 ml) was stirred at room temperature for 15 minutes, subsequently admixed with KOH (0.3 ml of a 1.7 M solution, 0.5 mmol) and the mixture was stirred for another 5 minutes. PhB(OH)₂ (370 mg, 3.0 mmol) and, 5 minutes later, cyclohex-2-enone (103 mg, 1.0 mmol) were added to the orange solution. The mixture was maintained at 55° C. for 2 hours and the course of the reaction was followed by GC (capillary HP-5: 90° C. for 3 min, then heating to 180° C. at a heating rate of 3° C. min⁻¹; flow rate: 1.6 ml of H₂ min⁻¹; retention times: 2.93 min. and 18.6 min). Under these conditions, the following results were obtained:

5 mol % of catalyst: 86% conversion; 3 mol % of catalyst: 81% conversion; 1 mol % of catalyst: 51% conversion. The enantiomeric excess (92-95%) was determined by means of chiral HPLC (Chiralcel OD-H, n-hexane: iPrOH=98: 2, retention times: R: 26.3 min.; S: 31.3 min. The product formed predominantly had the R configuration.

### Example 9

### 1,4-addition of PhB(OH)₂ onto 1-benzylpyrrole-2,5 dione

A solution of [Rh₂(μ₂-Cl)₂(C₂H₄)₄] (5 mg, 13 μmol) and S-^{Ph}tropp^{Ph} (13 mg, 28 μmol) in 1,4-dioxane (3 ml) was stirred at room temperature for 15 minutes, subsequently admixed with KOH (0.25 ml of a 1.0 M solution, 0.5 mmol) and the mixture was stirred for another 5 minutes.

PhB(OH)₂ (185 mg, 1.5 mmol) and, 5 min later, (1-benzylpyrrole-2,5-dione) (97 mg, 0.5 mmol) were added to the orange solution. The mixture was maintained at 55° C. for 2 hours and the course of the reaction was followed by GC (capillary HP-5: 90° C. for 3 min, then heating to 180° C. at heating rate of 4° C. min⁻¹; flow rate: 1.6 ml of H₂ min⁻¹; retention times 23.1 min. and 34.1 min.). Under these conditions, the following results were obtained: yield: 93%, the enantiomeric excess (79%) was determined by means of chiral HPLC (Chiralcel OD-H, n-hexane: iPrOH=98:2, retention times: R: 25.3 min.; S: 21.1 min. The product formed predominantly had the R configuration. Complete conversion was observed at a catalyst usage of 0.1%.

### Examples 10-19

### Hydrogenations of substrates using the catalyst [Ir(S-^{Ph}tropp^{Ph})₂]OTf (pH₂˜2.5 and T=298 K.

| | | | | | |
|---|---|---|---|---|---|
| | | t | | | |
| Example | Solvent | [min] | S/C | Conversion % | ee % |

Hydrogenations of itaconic acid

| | | | | | |
|---|---|---|---|---|---|
| 10 | MeOH | 120 | 200 | >99 | 30 |
| 11 | THF | 120 | 200 | >99 | 21 |
| 12 | MeOH | 120 | 4000 | 74% | 23 |

Hydrogenations of dimethyl 2-methylenesuccinate

| | | | | | |
|---|---|---|---|---|---|
| 13 | CH₂Cl₂ | 60 | 4000 | 90 | 60 |
| 14 | CH₂Cl₂ | 1200 | 10 000 | 85 | 60 |

Hydrogenations of dibutyl 2-methylenesuccinate

| | | | | | |
|---|---|---|---|---|---|
| 15 | CH₂Cl₂ | 120 | 200 | >99 | 67 |
| 16 | CH₂Cl₂ | 120 | 2000 | >99 | 58 |

Hydrogenations of methyl 2-acetamidoacrylate

| | | | | | |
|---|---|---|---|---|---|
| 17 | CH₂Cl₂ | 120 | 100 | >99 | 39 |
| 18 | CH₂Cl₂ | 120 | 4000 | 23 | 39 |
| 19 | CH₂Cl₂ | 120 | 10 000 | 7 | 39 |

1. Compounds of the formula (I) 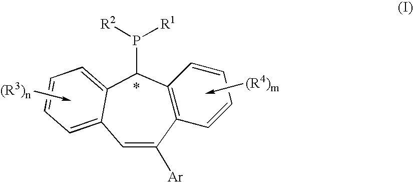
where
R¹ and R² are each, independently of one another, a monovalent radical containing from 1 to 30 carbon atoms or the moiety PR¹R² is a 5-to 9-membered heterocyclic radical which contains a total of from 2 to 50 carbon atoms and can contain up to 3 further heteroatoms selected from the group consisting of oxygen and nitrogen and
n and m indicate the number of substituents other than hydrogen on the aromatic ring and can each be, independently of one another, zero, one, two, three or four,
R³ and R⁴ are each selected independently from the group consisting of
fluorine, chlorine, bromine, iodine, nitro, free or protected formyl, C₁-C₁₂-alkyl, C, C₁₋₂-alkoxy, C₁-C₁₂-halogenalkoxy, C₁-C₁₂-halogenalkyl, C₅-C₁₄-aryl, C₆-C₁₅-arylalkyl and radicals of the formula (II),
A-B-C-D (II)
where, independently of one another
A is absent or is an alkylene radical having from 1 to 12 carbon atoms or an alkenylene radical having from 2 to 12 carbon atoms and
B is absent or is oxygen, sulphur or NR⁵,
where
R⁵ is hydrogen, C₁-C₈-alkyl, C₆-C₁₅-arylalkyl or C₅-C₁₄-aryl and
C is a carbonyl group and
D is R⁶, OR⁶, NHR⁷ or N(R⁷)₂,
where
R⁶ is C₁-C₈-alkyl, C₆-C₁₅-arylalkyl or C₅-C₁₄-aryl and
the radicals R⁷ are each, independently of one another C₁-C₈-alkyl, C₆-C₁₄-arylalkyl or C₅-C₁₄-aryl or the moiety N(R⁷)₂ is a 5- or 6-membered cyclic amino radical, and radicals of the formula (IIIa-g)
A-D (IIIa)
A-SO₂-D (IIIb)
A-NR⁶—SO₂R⁶ (IIIc)
A-SO₃Z (IIId)
A-PO₃Z₂ (IIIe)
A-COZ (IIIf)
A-CN (IIIg)
where A, D and R⁶ are as defined under the formula (II) and Z is hydrogen or a metal ion equivalent,
Ar is an aryl radical and
* denotes, independently of the depiction chosen above, that all possible stereoisomerically enriched compounds are encompassed.

2. The following compounds according to claim 1:
(S)- and (R)-10-phenyl-5-diphenylphosphanyl-5H-dibenzo[a,d]cycloheptene (S-^{Ph}tropp^{Ph}, R-^{Ph}tropp^{Ph}), (S)- and (R)-10-phenyl-5-di(o-tolyl)phosphanyl-5H-dibenzo[a,d]cycloheptene (S-^{Ph}tropp^{o-Tol}, R-^{Ph}tropp^{o-Tol}), (S)- and (R)-10-phenyl-5-di(m-tolyl)phosphanyl-5H-dibenzo[a,d]cycloheptene (S-^{Ph}tropp^{m-Tol} R-^{Ph}tropp^{m-Tol}) and (S)-, and (R)-10-phenyl-5-di(p-tolyl)phosphanyl-5H-dibenzo[a,d]cycloheptene (S-^{Ph}tropp^{p-Tol} R-^{Ph}tropp^{p-Tol}) with even greater preference being given to (S)- and (R)-10-phenyl-5-diphenylphosphanyl-5H-dibenzo[a,d]cycloheptene (S-^{Ph}tropp^{Ph}, R-^{Ph}tropp^{Ph}).

3. Process for preparing compounds according to claim 1, characterized in that
in a first step a),
compounds of the formula (IV) 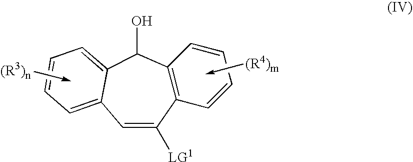
where R³ and R⁴ and also n and m are as defined in claim 1 and
LG¹ is halogen, perfluorocarboxyl or an organic sulphonate,
are reacted with compounds of the formula (V)
Ar-LG² (V)
where Ar is as defined in claim 1 and LG² is halogen, perfluorocarboxyl, B(OH)₂ or an organic sulphonate, in the presence of a catalyst to convert them into compounds of the formula (VI) 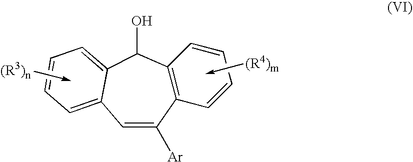
in a step b), the compounds of the formula (VI) are reacted with compounds of the formula (VII)
R¹R²PHal (VII)
where R¹ and R² are as defined in claim 1 and Hal is chlorine, bromine or iodine, preferably chlorine,
in the presence of acid to convert them into compounds of the formula (VIII) 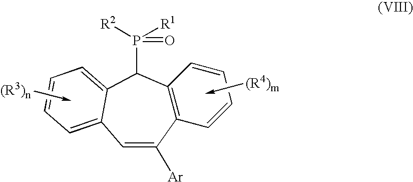
in a step c), the compounds of the formula (VIII) are converted by chromatography into stereoisomerically enriched compounds of the formula (VIII) and
in a step d), the stereoisomerically enriched compounds of the formula (VIII) are converted by reduction into compounds of the formula (I).

4. An asymmetric catalytic process wherein it is carried out in the presence of compounds according to claim 1 or 2.

5. Process for preparing stereosiomerically enriched chiral compounds, wherein it is carried out in the presence of compounds of the formula (I) according to claim 1 or 2.

6. Transition metal complexes containing compounds according to claim 1 or 2.

7. The following transition metal complexes according to claim 6:
S,S- and R,R-[Ir(^{Ph}tropp^{Ph})₂]OTf, S- and R-[Rh(cod)(^{Ph}tropp^{Ph})]OTf, S- and R-[Rh(MeCN)₂(^{Ph}tropp^{Ph})]PF₆ and S- and R-[RhCl(MeCN)(^{Ph}tropp^{Ph})].

8. Catalysts containing transition metal complexes according to claim 6 or 7.

9. A process for preparing stereoisomerically enriched compounds wherein it is carried out in the presence of catalysts according to claim 8.
